(19) United States
(12) Patent Application Publication
(10) Pub. No.: US 2006/0010425 A1
(43) Pub. Date: Jan. 12, 2006

(54) Methods and apparatus for automated mangement of software

(76) Inventors: Gloria J. Willadsen, Cedar Run, NJ (US); Bruce A. Meyer, Mountainside, NJ (US); Thomas J. Duffy, Forked River, NJ (US)

Correspondence Address: STRAUB & POKOTYLO, 620 TINTON AVENUE, BLDG. B, 2ND FLOOR, TINTON FALLS, NJ, 07724, US

(21) Appl. No.: 10/281,945

(22) Filed: Oct. 28, 2002

Related U.S. Application Data
(60) Provisional application No. 60/341,016, filed on Oct. 29, 2001.
(60) Provisional application No. 60/341,017, filed on Oct. 29, 2001.

(51) Int. Cl. G06F 9/44

(52) U.S. Cl. 717/120

(57) ABSTRACT

Software management methods and apparatus for performing software configuration management operations and for supporting build processes are described. Both implied and explicit dependency relationship information is captured and intelligently used in an automated fashion avoiding or reducing the need for human tracking of such relationships. Temporary or non-persistent data elements used during various phases of the software development process are automatically detected, including for example environment variables and their values and the versions of tools used to operate on the software components. A persistent association is created and stored between the normally temporary data element(s) and the software component(s) they affect. Implicit dependencies between data elements and software components are also automatically updated and revision-controlled, making historical and current implicit dependencies persistent. A software management information data base including implicit dependency relationship and explicit dependency relationship information is created. The information reflects explicit or implied relationships between various software components.

### RELATED APPLICATION

The present invention claims benefit of U.S. Provisional Patent Application No. 60/341,016 filed on Oct. 29, 2001 which has the title of “Methods and Apparatus for Simplifying the Navigation and Management of Nodal Hierarchies and Structures Associated with Operations Windows Displayed by a Graphical User Interface” and U.S. Provisional Patent Application No. 60/341,017 filed on Oct. 29, 2001, titled Software Based Methods and Apparatus for Managing Dependency Relationships Between Objects and to Detect and Initiate Actions Based on Changes in Explicit or Implicit Dependencies, and to Provide a Generalized and Efficient Way of Applying These Dependency and Change Based Capabilities of the Implementation of Systems Including Software Configuration Management”, both of which are of which are hereby expressly incorporated by reference.

### FIELD OF THE INVENTION

The present invention relates to software management, and, more particularly, methods and apparatus for automating software management functions.

### BACKGROUND OF THE INVENTION

Computers and the software that makes them useful have found numerous applications. Each software application normally includes one or more components, e.g., modules. Software applications are comprised of software components. Software components include, e.g., program components, data components and/or one or more combined program-data components.

During the initial development of a software application each component of the application may undergo many revisions. In addition, over a period of time, different versions of a software application may be released with different versions of some but not all of the application's components differing from the components of a previous version of the application.

Changes to software components are reflected in changes to the component's contents and thus, changes may be detected by examining a module's contents and comparing the contents to the contents of a previous version of the component. Different versions of software components are often identified by changes in version numbers and/or date information associated with the changed component.

Various dependency relationships may exist between different software components which comprise an application. Some dependency relationships may be explicitly set forth in a component through a written reference to another component, e.g., through the use of an “include” statement referencing the other component. Other dependency relationships, ones which are not explicitly stated in a component may also exist. For example, if a first program component includes code to modify a data component used by a second program component, a relationship exists between the first and second program components. Since this relationship is not explicitly stated in the body of any of the components, i.e., the first program component does not explicitly reference the second program component the relationship is sometimes called an implied or implicit dependency relationship.

Different programmers frequently work on writing, updating, and debugging different software components. Revisions to one component can often have an unexpected impact on another component due to an implicit dependency between the two components. This makes maintaining large applications a difficult and time consuming task often involving a large amount of programmer time simply to keep track of implied dependencies between software components and their potential effect when changes are made on related components.

Software configuration management is a phrase sometimes used to describe the task of managing revisions to software components and maintaining one or more versions of an application.

The first widely used software configuration management (SCM) tools were the source code control system (SCCS) in AT&T's Unix and the similar RCS in Berkley Unix. These tools provide file-level revision tracking but failed to track higher-level abstractions such as related groups of changes and project releases. Today some SCM tools on the market, e.g. Lucent's Sablime, Rational's ClearCase, and Merant's Dimension, have added support for at least some change or project release tracking. Unfortuantely, none of these SCM tools create or maintain information about the implied relationships and dependencies of the software components they are tracking (or managing) or the implied dependencies from environment variables and the like.

The current tools typically do not impose structure in the storage of the software they manage beyond that provided by the programmer setting up the tools and providing the software to provide the limited management functions. Since the tools do not store implied relationship information, e.g., in a database along with explicit relationship information, and they do not impose a storage structure on the software components themselves, known tools do not have the ability to manage the software to the degree desired.

A good example of the shortcomings of the known management tools is the chaos caused when a project file structure is reorganized to split a project as it grows into more variant versions and releases. The goal of that split is usually to share the common parts of the software and provide for more efficient development of the unique parts by different groups of programmers. Invariably, when this occurs programmers have to revise many if not all of the scripts and programs they wrote to make the tools work since the tools do not store or use dependency relationship information.

Associated with every software development project, there is normally a set of configuration and/or build data that is not persistent (i.e., it is lost after the system is powered off or the programmer logs out) or that is stored in a static form not easily tracked or revision-controlled. This data is usually defined during what is called the “build” process, which are the operations performed to turn source code into machine libraries or executables. An example of such data would be an environment variable used to pass certain flags to a compiler. The developer working on a project has to note the values of this data in scripts (e.g. programs written in a scripting language), profiles or in text notes. These scripts, profiles and notes often have to be retrieved, copied and changed for each platform, architecture and feature. Then the developer is responsible for making sure the right version of the right script file, or the right value for an environment variable is being used when doing certain compilation operations. This is one of the most, if not the most, confusing and fault prone series of steps encountered during the software build process. Sincere attempts are made by developers to revision-control scripts, profiles and text lists of this data, but this results in so many versions of these data files that even with a useful naming convention, these data files can become unmanageable and, in short order, indecipherable. Almost always the question of exactly which script file, profile or environment settings were used to produce a particular release arises. Reproducing this information reliably proves to be nearly impossible in many cases.

To circumvent this problem permanently, some developers write an elaborate profile mechanism. In these cases, there is a strict profile naming and project path convention that must be followed to be able to exactly reproduce releases using configuration and build data that is not persistent. Even though this mechanism and the profiles can be revision-controlled, there still is no knowledge inherent to the SCM software of the relationship between this data and it's effects on the related source code. Current tools do not detect changes in this temporary data, element by element, and also do not determine which action to perform on what files based on such changes.

In view of the above discussion, it is apparent that there is a need for improved methods and apparatus for managing software components and keeping track of revisions to software components and potential affects such revisions may have on other components.

### SUMMARY OF THE INVENTION

The present invention is directed to improved software management methods and apparatus. Various exemplary embodiments are directed to improved methods and apparatus for performing software configuration management operations and for supporting build processes. The method of the present invention provides for capturing and intelligently using dependency relationship information in an automated fashion that avoids or reduces the need for human tracking of implied relationships. Using the invention, temporary or non-persistent data elements used during various phases of the software development process are automatically detected, including for example environment variables and their values and the versions of tools used to operate on the software components. A persistent association is created and stored between the temporary data element and the software component(s) it affects. Such stored association information reflects a detected implicit dependency between the temporary data element and software component(s). Temporary data elements, their values, and other properties of these data elements are stored as part of a set of implicit dependency relationship information. Implicit dependency relationship information is automatically detected and revision controlled, making historical and current values and states of implicit dependency relationship information persistent. Implicit dependencies between these data elements and software components (including other temporary data elements) are also automatically updated and revision controlled, making historical and current implicit dependencies persistent.

The methods and apparatus of the present invention also revision-control and make persistent explicit dependency relationship information. Explicit dependency information includes information about explicit dependence's, i.e., literal references in a software component to another software component.

Unlike current SCM tools, the methods and apparatus of the present invention can recognize potential inconsistencies or conflicts between software components based on explicit dependencies and correctly resolve the problem automatically or via user prompts (e.g. when there are multiple header files with the same name). The present invention, by storing explicit dependency relationship information via an automated revision-control process together with the associated implicit dependencies and implicit dependency relationship information reduces or eliminates the need for scripts, command line commands, and text notes frequently used to recreate the temporary data often needed for recreating and building releases of software projects.

In accordance with the invention when a project is reorganized, the present invention knows the dependency relationships, e.g., both implied and explicit, for the software components and can automatically perform the restructuring, making changes that normally require extensive programmer effort.

The present invention provides a method to access and reproduce each piece of data and it's corresponding relationships affecting any version of a managed project. Using the present invention a user can view implicit dependencies and implicit dependency relationship information in the context of explicit dependencies and explicit dependency relationship information.

In at least one embodiment, the present invention provides a method for the dependency relationship information to be propagated and inherited within or across projects. Following either a manual change or automatic change being detected in the managed software components, the present invention recursively traverses explicit dependencies and executes implicit dependencies that are determined to be associated with a change providing a method and apparatus that can be used to provide automatic and cascading change-control capability.

### BRIEF DESCRIPTION OF THE DRAWINGS

FIG. 1 illustrates a computer system implemented in accordance with one embodiment of the present invention.

FIG. 2 illustrates a memory which includes a set of application programs and program data that may be used in the computer system of FIG. 1.

FIG. 3 is a flow diagram showing the steps involved in the initial generation of the management information database of the present invention.

FIG. 4 is a flow diagram showing the steps performed under direction of a change management control module of the present invention.

FIG. 5 is a flow diagram showing the steps performed under direction of a change management monitoring module of the present invention.

FIG. 6 is a flow diagram showing the steps performed under direction of a decision module of the present invention.

FIG. 7 is a flow diagram showing the steps performed under direction of the software component action module of the present invention.

FIG. 8 is a flow diagram showing the steps performed under direction of the implicit dependency action module of the present invention.

FIG. 9 is a flow diagram showing the steps performed under direction of the explicit dependency action module of the present invention.

FIG. 10 illustrates the relationships of FTOs and FDOs to software components in an object oriented embodiment of the present invention.

FIG. 11 illustrates the relationships of POs, COs, FSOs, FDOs, and software components in the object oriented embodiment of the present invention.

### DETAILED DESCRIPTION

The present invention relates to methods and apparatus for automatic management of software components and dependencies between software components. Changes in software components and dependencies are automatically detected in accordance with the invention and relationship information is updated to reflect the detected changes.

The methods of the present invention will be described in the general context of computer-executable instructions, such as program modules, executed by a computer. However, the methods of the present invention may be effected by other apparatus. Program modules may include applications, routines, programs, objects, components, data structures, etc. that perform task(s) or implement particular abstract data types. Moreover, those skilled in the art will appreciate that at least some aspects of the present invention may be practiced with other configurations including handheld devices, multiprocessor systems, network computers, minicomputers, mainframe computers, and the like. At least some aspects of the present invention may also be practiced in distributed computing environments where tasks are performed by remote processing devices linked through communications networks. In a distributed computing environment, program modules and data may be located in local and/or remote memory storage devices.

Various terms are used in the discussion of the invention which follows. For purposes of the present application, various terms are defined as follows:

Software Component—A program component, data component or combined program-data component.

Explicit Dependency (ED)—A literal reference contained in a software component to another software component, e.g. a “#include.”

Explicit Dependency Relationship Information (EDRI)—Information that specifies, one or more relationships between software components, where each specified relationship is based on an ED, e.g., information mapping one SC to another SC based on an ED.

Nodal Tree Structure (NTS)—A tree structure implementation of EDRI.

Implicit Dependency (ID)—An implied relationship between two or more software components.

Implicit Dependency Relationship Information (IDRI)—Information about an implicit dependency that, at least, explicitly specifies an implied relationship between two or more software components. Implicit dependency relationship information may include a command and/or data associated with an implicit dependency.

Program Component (PC)—One or more computer instructions, e.g., a command or executable portion of a computer program.

Data Component (DC)—A non-executable set of information, e.g., information that can be used by a software component or rule.

Program and Data Component (PC-DC)—A combination comprising one or more computer instructions and a non-executable set of information.

Command—An executable command or executable code.

Keeping the above definitions in mind, the invention will now be explained in detail.

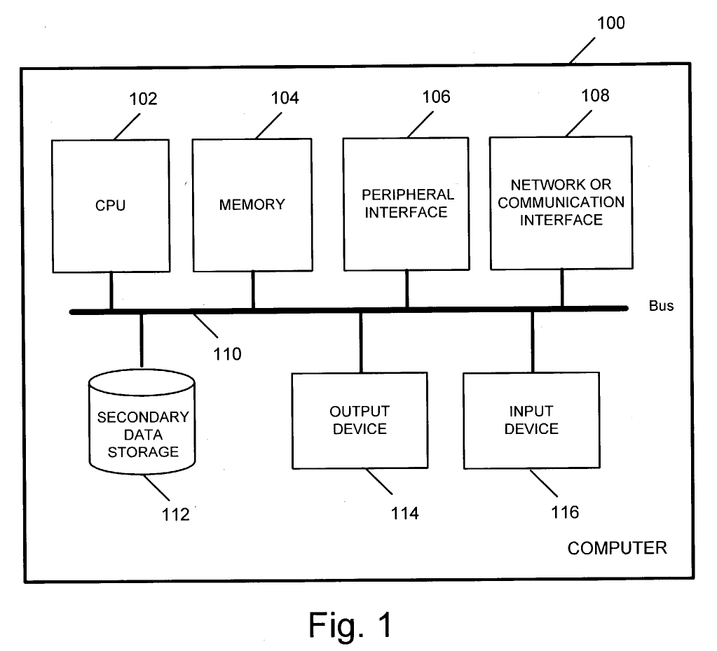

With reference to FIG. 1, an apparatus, e.g. computer system 100, for implementing at least some aspects of the present invention is shown. The system 100 includes a CPU 102, memory 104, a peripheral interface 106, a network or communication interface 108, secondary storage 112, an output device 114, and an input device 116, which are coupled together by a bus 110 as shown in FIG. 1. In one embodiment of the present invention a user may enter a command to the computer 100 using an input device 116 to cause the present invention to perform its intended function.

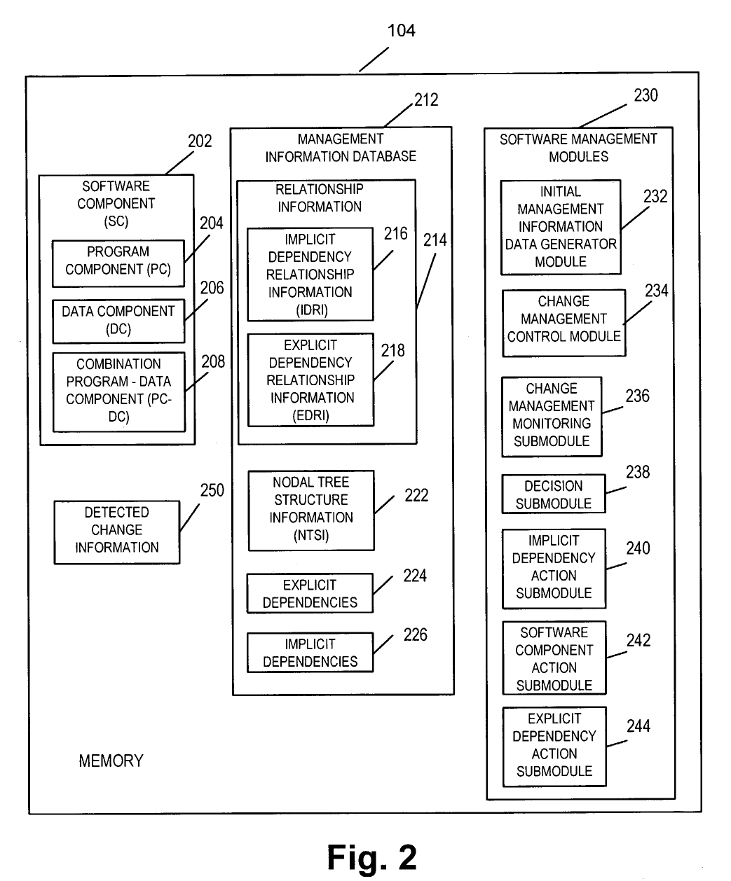

As illustrated in FIG. 2, a number of program modules and data elements may be stored in the memory 104. Those skilled in the art will appreciate that the program modules and data elements may also be stored in other apparatus including secondary storage 112. One group of program modules and data elements are software components 202. Software components 202 include program components 204, data components 206, and combination program-data components 208. Software components 202 may be automatically managed in accordance with the present invention.

Memory 104 also includes a management information database 212. Management information database 212 includes relationship information 214, nodal tree structure information (NTSI) 222, a list of explicit dependencies 224 and a list of implicit dependencies 226. Relationship information 214 includes both implicit 216 and explicit 218 dependency relationship information.

In addition to management information database 212, the memory 104 includes software management modules 230. Software management modules 230 include an initial management information data generator module 232, a change management control module 234, a change management monitoring submodule 236, a decision submodule 238, an implicit dependency action submodule 240, a software component action submodule 242, and an explicit dependency action submodule 244.

In accordance with the present invention, changes to software components may be detected. Memory 104 includes information 250 about changes to software components which are detected, e.g., automatically, in accordance with the present invention.

The contents and uses of each of the elements included in memory 104 will be explained further below.

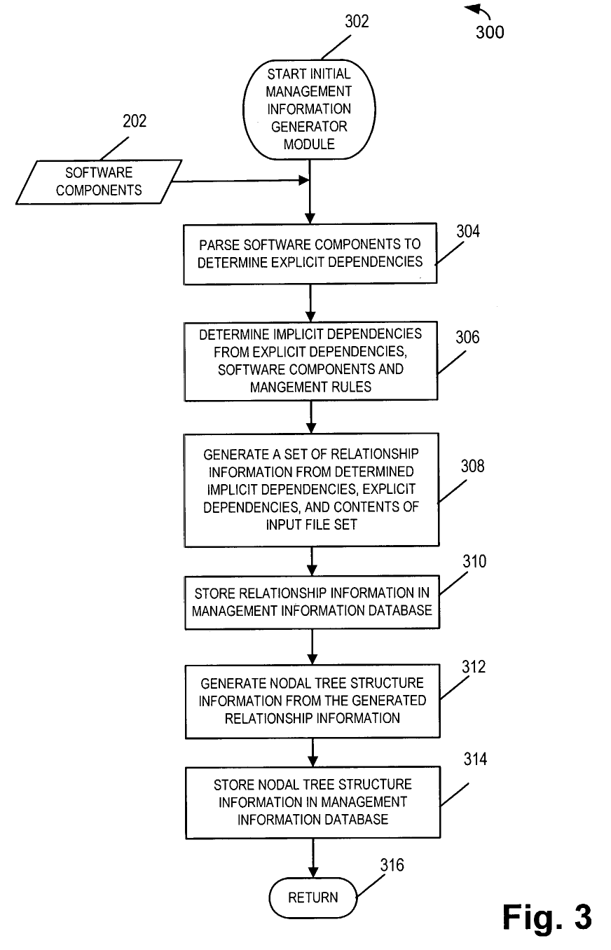

FIG. 3 illustrates the steps performed by the system 100 under the direction of the initial management information data generator module 232. The initial management information data generator module 232 may be invoked by a user of the system 100 or by another module, e.g., change management module 234.

The initial management information generation process 300 begins in step 302 with the module 332 being executed by cpu 102. From step 302, operation proceeds to explicit dependency parsing step 304 that uses as input software components 202, e.g., as specified by a user. Software components 202 are available from memory 104. Parsing in step 304 involves using one or more existing techniques to find explicit dependencies in the software components 202. After the explicit dependencies are identified and stored, e.g., as a set or list of explicit dependencies 224, processing proceeds to step 306. In step 306 implicit dependencies for the software components 202 are determined from the explicit dependencies 224, software components 202, and/or information from a user via an interactive dialog using input device 116 and output device 114. The determined implicit dependencies are stored in memory as implicit dependencies 226. With the explicit and implicit dependencies determined, operations proceeds to step 308.

In step 308 a set of relationship information 214 mapping the relationships among explicit dependencies 224, implicit dependencies 226, and software components 202 is generated. Operation then proceeds to step 310 where this information is stored in memory as implicit dependency relationship information 216 and explicit dependency relationship information 218. Operation then continues in step 312 where nodal tree structure information 222 is generated. Such information represents a nodal view of the determined dependency relationships with nodes corresponding to software components and links between nodes corresponding to the determined relationships. The nodal tree structure information 222 may be presented to a user in graphical form on output device 114.

Following step 312, in step 314, the nodal tree structure information is stored in management information database 212. The next step is 316 where the initial management information generator module 232 ends. In the event the initial management information data generator module was executed in response to a call form another module, e.g., change management control module 234, control will be returned in step 316 to the calling module, e.g., change management control module 234.

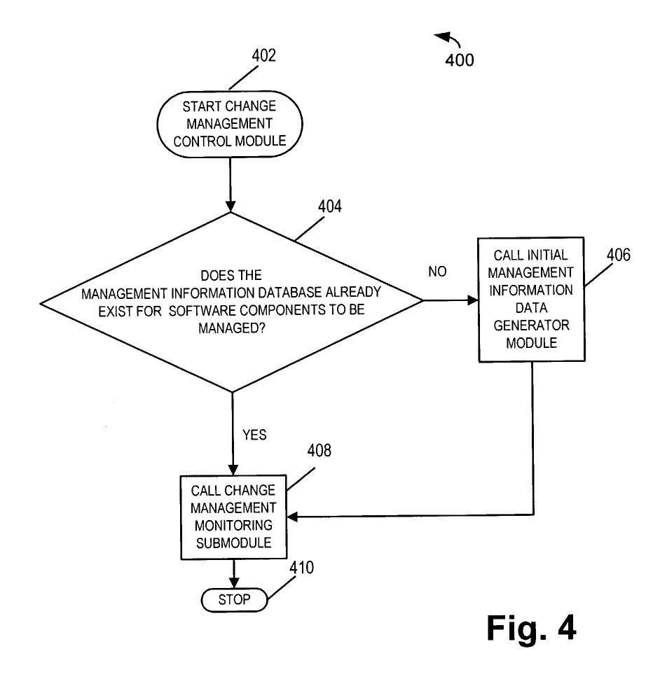

The various steps performed by the present invention will now be explained in detail beginning with reference to the flow chart of FIG. 4. As illustrated in FIG. 4 operation begins with the change management control module 234 beginning with step 402. After step 402 operation proceeds to step 404, where a check is performed to determine whether the management information database 212 already exists for the software components to be monitored. If the management information database 212 exists then operation proceeds directly to step 408. However, if the management information database 212 does not yet exist for the components, then in step 406 the initial management information data generator module 232 is called and operations proceed to step 302. The initial management information data generator module 232 analyzes the software components, e.g., specified by a user, and other information to build the management information database 212 for those components. After completing, the initial management information data generator module 232 performs a return operation and processing proceeds to step 408.

In step 408 the change management monitoring submodule 236 is called and operations proceed at step 502. When the change management monitoring submodule 236 returns, operations proceeds from step 408 to step 410 where operations halt, e.g., until a user once again activates the management control module 234.

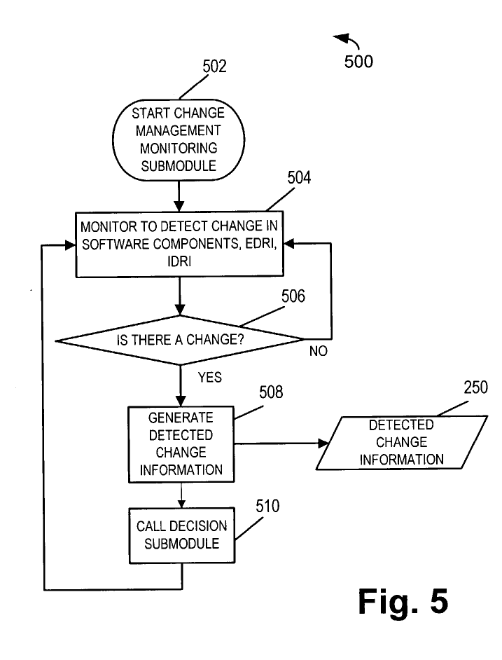

FIG. 5 illustrates the steps performed as part of a change monitoring process 500 under direction of the change management monitoring module 236 beginning with step 502. After initializing, operation proceeds to monitoring step 504 where software components, e.g., the components to be managed, are monitored to detect changes in the software components, implicit dependency relationships, and/or explicit dependency relationships which should be reflected in EDRI and IDRI 216, 218. The next step 506, determines if a change was detected in step 504. If no change was detected then control passes back to step 504. If a change was detected then operation proceeds to step 508. In step 508 the detected change information is processed to generate change information which is then stored in memory 104 as detected change information 250. The change information may include information indicating the date, time and revision number of a software component and/or application in which a change was detected. It may also include information clearly identifying, e.g., documenting, the detected change. Operation proceeds from step 508 to step 510. In step 510 the decision submodule 238 is called and operations proceed at step 602. When the decision control submodule 238 returns processing control to the change management monitoring submodule, operation will proceed from step 510 to step 504.

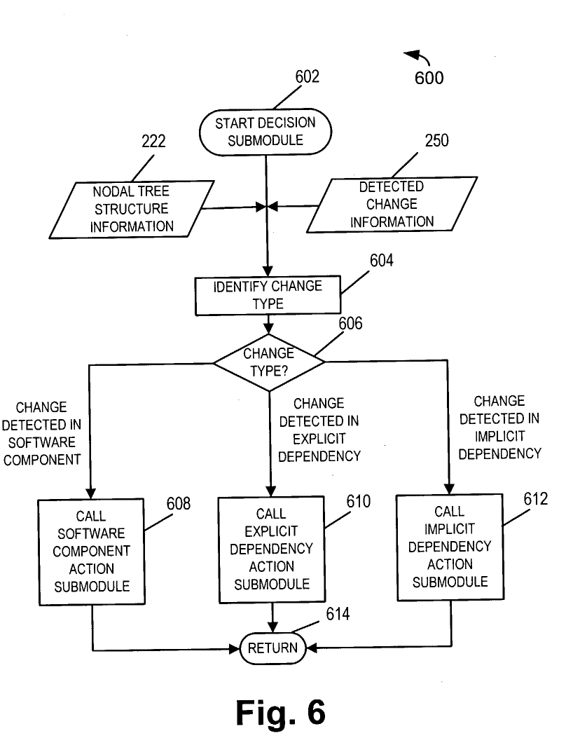

FIG. 6 shows the steps performed in accordance with a decision subprocess 600 under direction of the decision submodule 238. The decision subprocess 600 begins in step 602. After initializing, the decision submodule 238 proceeds to step 604 with the nodal tree structure information 222 and the detected change information 250 being passed for use in step 604 and the subsequent steps.

In step 604 the type of change that was detected and resulted in the decision submodule being called is identified, e.g., determined, and control passes to step 606. In the exemplary embodiment, a change may be determined to correspond to one of three change types, e.g., a change in a software component, a change in an explicit dependency, a change in an implicit dependency. Calls to the decisions submodule may result in the sequential processing of multiple changes that are detected in a software component, e.g., one change at a time. It should be noted that a change to an explicit dependency is one type of software component change but that such changes are treated as a separate type of change from other software component changes for purposes of decision submodule processing.

In step 606 the type of change is used to determine where operations will proceed. If the change is to a software component 202, other than an explicit dependency change, operation continues in step 608 where the software component action submodule 242 is called and operations proceed at step 702. If the change is to an explicit dependency 224, then operation continues in step 610 where the explicit dependency action submodule 244 is called and operations proceed at step 902. If the change is to an implicit dependency 226, then operation continues in step 612 where the implicit dependency action submodule 240 is called and operation proceeds to step 802. When any of the called modules, 240, 242, or 244 return, operation proceeds to step 614 which is a return step. This results in the decision submodule 238 returning to the completion point of step 510 of FIG. 5.

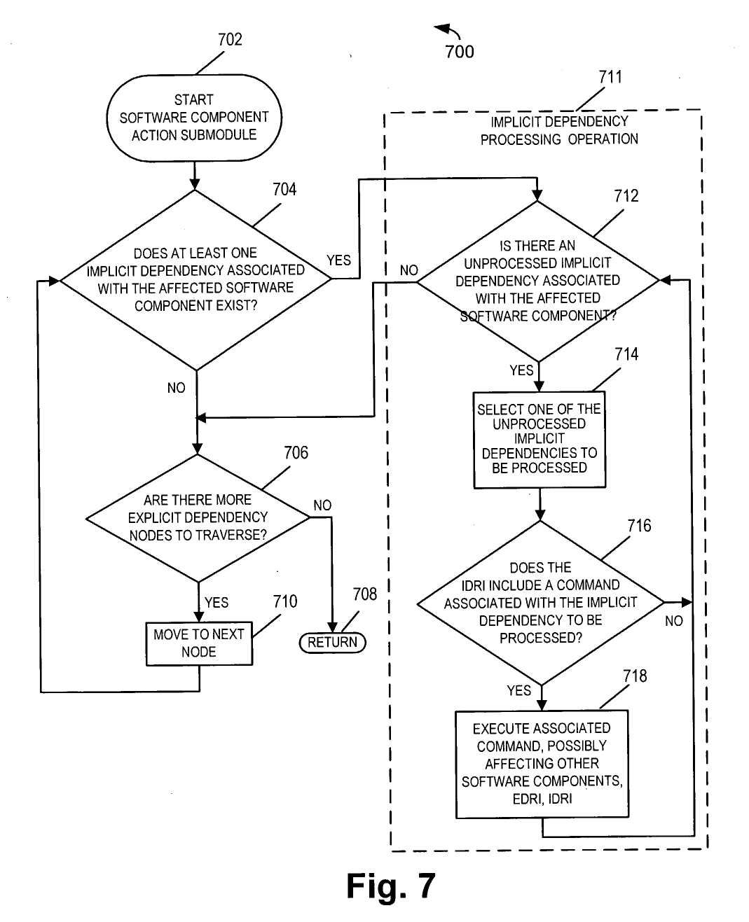

FIG. 7 illustrates the steps performed in accordance with a software component change action process 700 performed under direction of the software action component submodule 242. As discussed above, this module is called in response to detecting a non-explict dependency change in a software component. Processing begins in step 702 which the process 700 begins being executed. After initializing, the software component action submodule 242 proceeds to step 704 where the implicit dependency relationship information 216 is checked to determine whether at least one implicit dependency 226 is associated with the affected software component 202. If there is no implicit dependency 226 associated with the affected software component 202 the operations proceed to step 706 where the nodal tree structure 222 is checked to determine whether there are more explicit dependency nodes to traverse. One skilled in the art will recognize this as a standard tree traversal. If the check in step 706 finds there are no nodes to traverse then operation proceeds to step 708 and the software action component submodule 242 returns. If the check in step 706 finds there are additional nodes to traverse, then operations proceed to step 710 where the next node is identified. Operations then proceed to step 704. In step 704, if there is at least one implicit dependency 226 associated with the affected software component 202, then operations proceed to step 712 in the implicit dependency processing operation 711. In step 712, the implicit dependency processing operation 711 determines if there is an implicit dependency 226 associated with the affected software component 202 that has not been processed by step 718. If there is no unprocessed implicit dependency 226 then operations proceed to step 706. If there is at least one unprocessed implicit dependency 226 operations proceed to step 714 where one of the unprocessed implicit dependencies 226 is selected to be processed. From step 714 operation proceeds to step 716 where the implicit dependency relationship information 216 is checked to determine whether the selected implicit dependency has a command associated with it in the IDRI 216. If the implicit dependency does not have a command associated with it then operation proceeds to step 712 to check the IDRI 216 for another implicit dependency associated with the changed software component. If the associated implicit dependency has a command associated with it then operation proceeds to step 718 where the associated command is executed. Operation then proceeds to step 712 in which the software component action submodule 242 tries to find software components 202 and implicit dependencies related to a changed software component 202. In step 712 the submodule 242 may perform one or more management actions to effect changes implied by the affected relationships prior to proceeding to step 714.

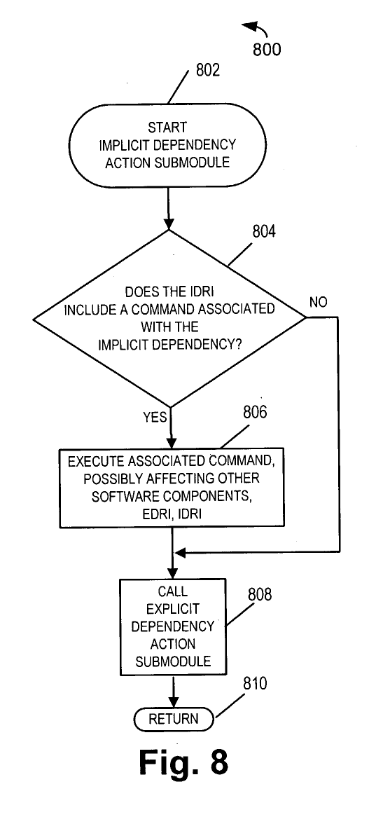

FIG. 8 illustrates the steps performed in an implicit dependency action process 800 under direction of the implicit dependency action submodule 240. The process 800 begins with step 802. After initialization, the implicit dependency action submodule 240 proceeds to step 804. At step 804 the implicit dependency relationship information 216 is checked to determine whether there is a command associated with the selected implicate dependency in IDRI 226. If there is no associated command then operation proceeds to step 808. If the IDRI 226 includes an associated command then operation proceeds to step 806 where the associated command is executed. Operation then proceeds to step 808. In step 808 the explicit dependency action submodule 244 is called. When operation returns from the explicit dependency action submodule 244, operation proceeds to step 810 where the implicit dependency action submodule 240 performs a return operation. In the above described manner, the set of steps 800 corresponding to the implicit dependency action submodule 240, executes a command, if any, associated with the selected implicit dependency 226 and then calls the explicit dependency action submodule 244.

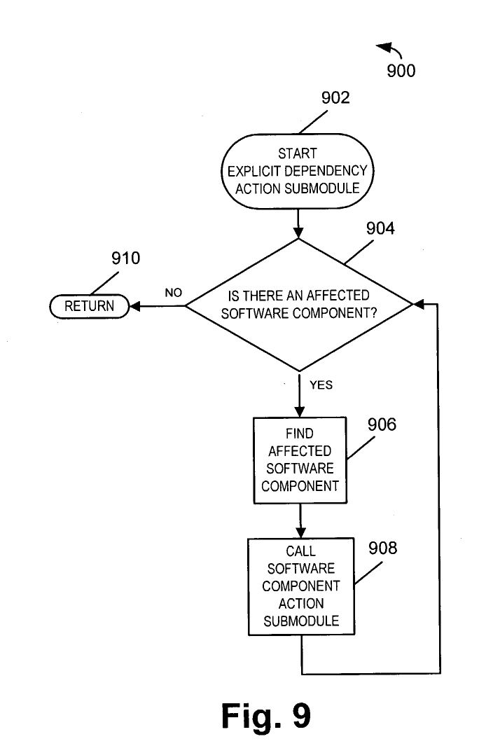

FIG. 9 illustrates the steps of a process 900 performed under direction of the explicit dependency action submodule 244. The process 900 begins with step 902 wherein the submodule is initialized. After initializing, the explicit dependency action submodule 244 proceeds to step 904. In step 904 a determination is made as to whether there is a software component 202 affected by the change detected in the decision submodule 238 or any change springing from that change including changes resulting from execution of commands due to the detected change. If there is no affected software component 202 then operations proceed to step 910 and the explicit dependency action submodule 244 performs a return operation. In step 904, if there is an affected software component 202 then operation proceeds to step 906 where the affected software component 202 is identified. Operation proceeds to step 908 where the software component action submodule 242 is called. When the software component action submodule 242 returns, operation will proceed to step 904.

Object oriented programming provides an extremely efficient way to implement the methods of the present invention. In an Object-Oriented embodiment, modules, e.g., objects, are stored in memory 104 and processed, e.g., executed, by the CPU 102 to implement the methods of the invention. Techniques for implementing object oriented embodiment of the present invention are described at length in the U.S. Provisional Patent Application No. 60/341,016 filed on Oct. 29, 2001 which is hereby expressly incorporated by reference. The Object-Oriented (O-O) design described in the provisional application supports Software Configuration Management (SCM) in accordance with the methods of the present invention.

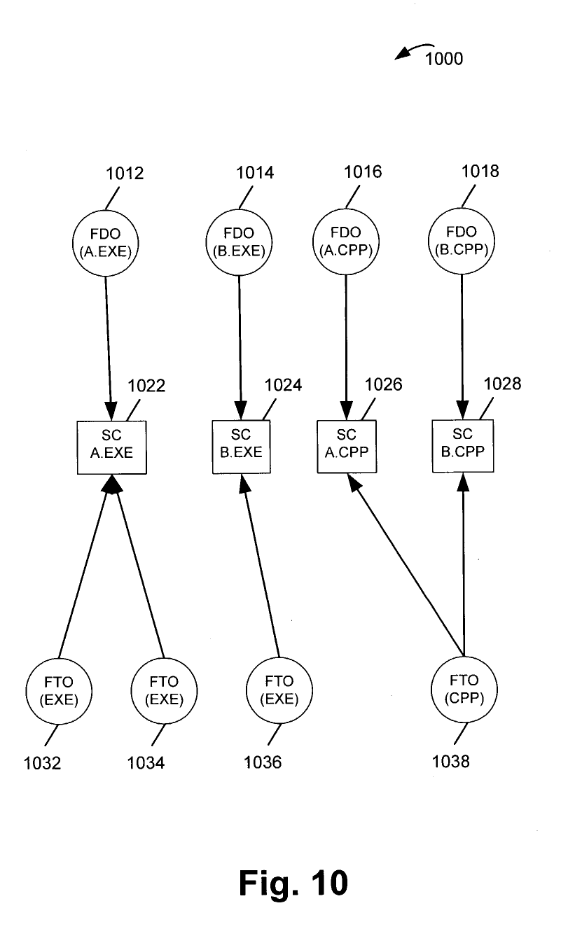

FIG. 10 illustrates the relationship of file type objects (FTOs) to software components in an exemplary object oriented embodiment of the present invention. FIG. 10 shows a plurality of FTOs, 1032, 1034, 1036, and 1038, a plurality of software components, 1022, 1024, 1026, 1028, and a plurality of file description objects, 1012, 1014, 1016, and 1018. In this embodiment, more than one FTO of the same type may be associated with the same software component, e.g., FTO 1032 and FTO 1034 are associated with SC 1022. An FTO may be associated with more than one file of the same type, e.g., FTO 1038 is associated with SC 1026 and SC 1028. An FTO may also be associated with a software component, e.g., FTO 1036 and SC 1024. As an example, in one embodiment, FTO 1032 includes build rules for a Windows NT environment and FTO 1034 includes build rules for a Windows 98 environment. The association of FTOs to SCs can be many to many, e.g. two or more software components of the same type may have the same dependency rules and share an FTO, two or more software components of the same type have different dependency rules and do not share an FTO, and a software component may have multiple dependency rules and be associated with multiple FTOs. An FDO is associated with a software component as shown in the figure where FDO 1012 is associated with SC 1022, 1014 with 1024, 1016 with 1026, and 1018 with 1028.

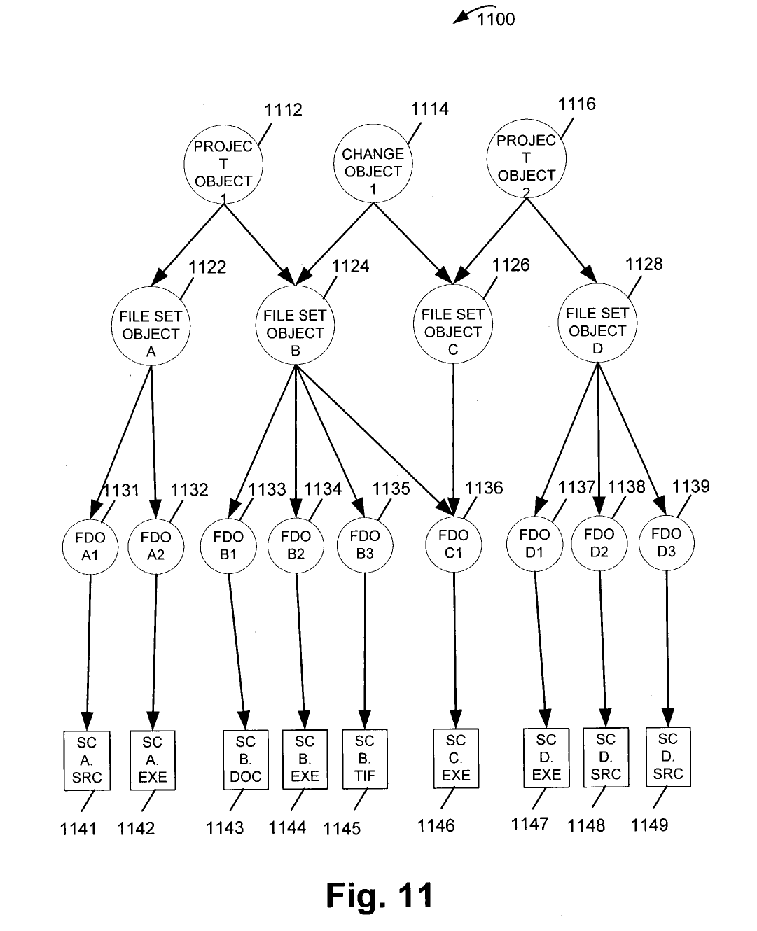

FIG. 11 illustrates the relationship of the major system objects to software components in the exemplary O-O embodiment of the present invention. A plurality of project objects (POs), 1112 and 1116, a change object (CO), 1114, a plurality of file set objects (FSOs), 1122, 1124, 1126, 1128, a plurality of file description objects, 1131, 1132, 1133, 1134, 1135, 1136, 1137, 1138, and 1139, and a plurality of software components, 1141, 1142, 1143, 1144, 1145, 1146, 1147, 1148, 1149 are shown. POs and COs are associated with one or more FSOs, for example, 1112 associated with 1122 and 1124, 1116 associated with 1126 and 1128, and 1114 associated with 1122 and 1126. FSOs are associated with one or more FDOs as shown by the lines in the figure. Each FDO is associated with one SC as shown by the lines in the figure.

In the exemplary O-O based implementation described in U.S. Provisional Patent Application No. 60/341,017 filed on Oct. 29, 2001, which is hereby expressly incorporated by reference, SCM is achieved through the use of five object classes and the relationships between such classes. These object classes include File Type Objects (FTOs), File Description Objects (FDOs), File Set Objects (FSOs), Project Objects (POs), and Change Objects (COs). In an O-O embodiment, a software object is a software component.

The O-O implementation of the present invention automates the management of dependencies between software components which take the form of software objects in the O-O embodiment. It also automates the detection of changes in the data or information included in the managed objects, i.e., software components.

In the O-O implementation, implicit dependency relationship information (IDRI) is stored in object classes comprised of FTOs and FDOs. Object classes comprising the referenced O-O implementation are normally software components external to the software components being managed.

The O-O implementation includes performing such steps as: storing implicit dependency relationship information that explicitly specifies at least one implied relationship between at least two software components, said implicit dependency being information stored external to said plurality of components; and monitoring to detect a change in at least one of said plurality of components.

Said O-O implementation also involves using stored IDRI to determine a software management action to be taken; and accessing stored IDRI, where said IDRI is stored in objects comprising FTOs and FDOs. Said O-O design involves using a CO to determine that a software component has changed. If such change has occurred it is determined that at least one implicit dependency exists for said changed software component, and then if the implicit dependency information includes a command associated with the said at least one implicit dependency, the associated command is executed.

Said O-O implementation also includes using FTOs, FDOs, and COs to determine if at least one implicit dependency exists for a changed software component, and if the implicit dependency information does not include a command then it is determined if there is another implicit dependency is associated with said changed software component.

In said O-O implementation explicit dependency relationship information (ERDI) is stored in objects including FSOs and POs. In said implementation using stored IDRI to determine a software management action to be taken further includes: determining from stored EDRI if there is an additional software component with an explicit dependency relationship information (EDRI) associated with the changed software component.

Said O-O implementation further uses objects comprising FTOs and FDOs to determine if at least one implicit dependency (ID) exists for said additional software component. As part of the O-O implementation one or more commands are executed.

As part of said O-O implementation monitoring to detect a change in IDRI stored in objects comprising FTOs and FDOs is performed; and, in response to detecting a change in IDRI which includes a command, the included command is executed.

Said O-O implementation includes methods that involve detecting a change in one of said software components resulting from executing said command included in changed IDRI; and using objects comprising FSOs, POs, and COs in determining a management operation to be performed based on whether the detected change was a program component, data component or combined program-data component.

In said O-O implementation, stored objects including FTOs, FDOs, FSOs, and POs are used to store a set of stored information comprising: IDRI associated with a plurality of software components, said IDRI information including a first explicit statement of an implied relationship (which is the definition of an implicit dependency or IR) determined from at least one of said software components.

Said O-O implementation includes a set of stored information that includes a command associated with said first explicit statement of an implied relationship. Furhtermore, in said O-O implementation, stored objects include a set of stored information that includes data associated with a second explicit statement of an implied relationship between at least two software components.

In said O-O implementation stored objects comprising said O-O implementation further include state information reflecting changes in at least one item that is from the set including a software component, IDRI, and EDRI. Stored objects including FSOs, POs, and COs include state information that includes the value of the item before and after a change in said item. POs may associate a different version number with each of a plurality of different versions of a stored item.

In said O-O implementation, stored objects comprising said O-O design comprise a database that stores IDRI associated with a plurality of software components, and said database stores a set of explicit dependency relationship information (EDRI) generated by examining said plurality of software components to identify explicit dependencies. Part of said O-O implementation is directed to examining objects comprising FTOs and FDOs, and storing an explicit statement of identified implicit dependencies in one or more of such objects. Said O-O implementation involves storing a command associated with the stored explicit statement of an identified dependency.

Part of said O-O implementation involves examining a plurality of software components to identify explicit dependency relationship information and storing a collection of identified explicit dependency relationship information with said stored explicit statement of the identified implied dependency in objects comprising said database.

Said O-O implementation involves monitoring to detect changes in software components and generating a database comprised of objects including COs for storing detected change in formation. Various parts of the O-O implementation involve building a database of objects comprising COs containing stored detected change information that includes system component information before and after a detected change. O-O implementations include storing in objects comprising said database, version number of a program component before and after a detected change in said program component.

Some examples which are useful in understanding the context, application and/or use of the methods and apparatus of the present invention are set forth below.

Example of an Explicit Dependency:
One line in file x.c reads as follows:
   #include “x.h”

This line refers to a file external to x.c called x.h. It implies that the file x.c is directly dependent on existence and contents of file x.h. This is referred to as an Explicit Dependency between files x.c and x.h.

Examples of Explicit Dependency Relationship Information for example (1) would be as follows:
Version 1.2 of file x.c has an Explicit Dependency on version 2.5 of file x.h.
Version 1.3 of file x.c has an Explicit Dependency on version 2.5 of file x.h.
Version 1.4 of file x.c has an Explicit Dependency on version 2.8 of file x.h and version 1.8 of file y.h.

As shown above, the Explicit Dependency Relationship Information reflects previous and current Explicit Dependencies.

An example of an Implicit Dependency follows:
The following commands are used, either in a script or manually typed by a user, to convert computer instructions contained in file x.c into an executable program named x.exe:
export $INCLUDE_PATH=“-I/usr/include—I/current/include”
gcc -g $INCLUDE_PATH x.c-o x.exe

The program file named gcc, along with certain parameters, are used to create the file x.exe from the file x.c. Therefore, the file x.c has an implied relationship with the program file named gcc, as well as with each parameter used to covert x.c to x.exe. These implied relationships are called Implicit Dependencies between x.c and the program file gcc, x.c and the parameter “-g”, x.c and parameter “-o” and x.c and the parameter variable “$INCLUDE_PATH”.

An example of Implicit Dependency Relationship Information involves changing the value of the $INCLUDE_PATH variable parameter shown above, as follows:
export $INCLUDE_PATH=“-I/usr/include-I.”
After the value of the variable has been changed, the following command, shown above, is executed once again:
gcc-g $INCLUDE_PATH x.c-o x.exe

The previous value of the variable as well as the current value is stored as Implicit Dependency Relationship Information as follows:
Version 1.1 of variable INCLUDE_PATH equals “-I/usr/include-I/current/include”
Version 1.2 of variable INCLUDE_PATH equals “-I/usr/include-I.”
Version 1.3 of file x.c depends on version 1.1 of variable INCLUDE_PATH
Version 1.4 of file x.c depends on version 1.2 of variable INCLUDE_PATH

An example of a nodal structure would be as follows:

Using the files x.c and x.h, where x.c has an explicit dependency on x.h as shown above, we would construct several nodal structures reflecting previous and current values of each file and all of its dependency information.

Node (a) represents version 1.3 of file x.c. Node (b) represents version 2.5 of file x.h. Since the file x.c has an Explicit Dependency on file x.h, this would be graphically represented by a line drawn from node (a) to node (b). Internally, node (a) is comprised of a reference to node (b), which is referred to as the Explicit Dependency Relationship Information for node (a). Node (a) is also comprised of a reference to version 1.1 of the variable INCLUDE_PATH, which is referred to as some of the Implicit Dependency Relationship Information for node (a). More Implicit Dependency Relationship Information would be a reference to the program file “gcc”, and references to the flags “-g” and “-o”.

Another nodal structure would be node (d), which represents version 1.4 of file x.c, and node (e) which represents version 2.8 of file x.h. Node (d) is internally comprised of a reference to node (e), which represents Explicit Dependency Relationship Information for node (d). Node (d) is also comprised of a reference to version 1.2 of the variable INCLUDE_PATH, which represents some of the Implicit Dependency relationship Information for node (d).

An example of operations, reusing the above files x.c and x.h is as follows:

Nodes (a) and (b) are placed at the top of another nodal structure not shown in previous examples. Graphically, this would happen via a “drag and drop” operation of nodes (a) and (b) from one project to another project. Now node (a), which represents version 1.3 of file x.c, appears at the topmost position of a nodal structure, and has more than one Explicit Dependency. The new Explicit Dependency for node (a) is node (f), which represents version 2.1 of file z.c. The original Explicit Dependency was also copied, and still exists as node (b), representing version 2.5 of x.h.

Version 2.1 of z.c is edited, creating version 2.2 of the same file. This creates a new node (g) which would refer to the new version of the file z.c, along with all unchanged Explicit and Implicit Dependency Relationship Information copied from node (f). The user determines that node (a) should point to the latest version of z.c, so the user changes the Explicit Dependency Relationship Information of node (a) to reference node (g) instead of node (f). The user also determines that the Implicit Dependency to build x.exe should now read as follows:
gcc-g $INCLUDE_PATH x.c-o x.exe z.o

The user makes this change to the Implicit Dependency referred to by node (a) and saves it.

Now the user selects node (a) and chooses an option to rebuild this node. The system will first find the Explicit Dependencies of node (a) and rebuild these. The system finds the Explicit Dependency node (g). The Implicit Dependencies pertaining to node (g) are evaluated, and the Implicit Dependencies which are commands are executed (not shown here, but assumed to be some compile command), producing the file z.o. The next Explicit Dependency from node (a), which is node (b), is evaluated. Since it has no Implicit Dependency Relationship Information, nothing is done to it. The Explicit Dependency from node (b) is traced backwards to node (a). The Implicit Dependencies pertaining to node (a) are evaluated. The command “gcc-g $INCLUDE_PATH x.c-o x.exe z.o” is discovered and executed. Since node (a) is at the top of the nodal structure, processing stops.

U.S. Provisional Patent Application No. 60/341,016 filed on Oct. 29, 2001 which has the title of “Methods and Apparatus for Simplifying the Navigation and Management of Nodal Hierarchies and Structures Associated with Operations Windows Displayed by a Graphical User Interface” which is expressly incorporated by reference describes various methods and apparatus for storing and using information representing nodal tree structures based on EDRI in accordance with the invention.

The provisional patent applications incorporated herein by reference are intended to provide additional examples of various embodiments of the present invention and are not intended to limit or narrow the scope of the invention through language describing a particular embodiment of the invention contained therein. Furthermore, to the extent that any language used in the provisional applications may differ from the definitions assigned herein, it is to be understood that for purposes of the present application, the definitions set forth above are to be controlling and that any differences in the language of the provisional applications is to be interpreted as applying to the incorporated text of the provisional applications and not the non-incorporated text of the present application.

Numerous variations on the above described methods and apparatus are possible while remaining within the scope of the present invention. For example, numerous O-O implementations as well as non-O-O based implementations of the above described methods are possible.

What is claimed is:

1. A method of processing software including a plurality of components, said software components including at least two components selected from the group including a program component, a data component, and a combined program-data component, the method comprising the steps of:
storing implicit dependency relationship information that explicitly specifies at least one implied relationship between at least two software components, said implicit dependency being information stored external to said plurality of components; and
monitoring to detect a change in at least one of said plurality of components.

2. The method of 1, further comprising:
in response to detecting a change in at least one of said plurality of components using stored implicit dependency relationship information to determine a software management action to be taken.

3. The method of claim 2, wherein using said stored implicit dependency relationship information to determine a software management action to be taken includes:
accessing the stored implicit dependency information to determine if at least one implicit dependency exists for the changed component; and
if it is determined that at least one implicit dependency exists for the changed component and said implicit dependency information includes a command associated with said at least one implicit dependency, executing said associated command.

4. The method of claim 3, if said at least one implicit dependency exists for the changed component and said implicit dependency information does not include a command associated with said at least one implicit dependency, determining if there is another implicit dependency associated with said changed software component.

5. The method of claim 3, further comprising:
storing explicit dependency relationship information; and
wherein using said stored implicit dependency relationship information to determine a software management action to be taken further includes:
determining from stored explicit dependency relationship information if there is an additional component with an explicit dependency to the changed component.

6. The method of claim 5, further comprising, when it is determined that there is an additional component with an explicit dependency relationship to the changed component, determining if at least one implicit dependency exists for said additional component.

7. The method of claim 6,
if it is determined that an implicit dependency exists for the additional component and said implicit dependency relationship information includes a command associated with the addition component, executing said command.

8. The method of claim 1, further comprising:
monitoring to detect a change in implicit dependency relationship information used to manage at least some of said plurality of software components; and
in response to detecting a change in implicit dependency relationship information which includes a command, executing said command.

9. The method of claim 8, further comprising:
detecting a change in one of said software components resulting from executing said command included in changed implicit dependency relationship information; and
determining a management operation to be performed based on whether the detected change was in a program component, data component or combined program-data component.

10. A machine readable medium including a set of stored information, the set of stored information comprising:
implicit dependency relationship information associated with a plurality of software components, said implicit dependency relationship information including a first explicit statement of an implied relationship determined from at least one of said software components.

11. The machine readable medium of claim 10, wherein the set of stored information further comprises:
a command associated with said first explicit statement of an implied relationship.

12. The machine readable medium of claim 10, wherein the set of stored information further comprises:
data associated with a second explicit statement of an implied relationship between at least two software components.

13. The machine readable medium of claim 10, wherein the set of stored information further comprises:
state information reflecting changes in at least one item, wherein said item is an item from the set including a software component, implicit dependency relationship information, and explicit dependency relationship information.

14. The machine readable medium of claim 13, wherein said state information includes the value of the item before and after a change in said item.

15. The machine readable medium of claim 14, wherein a different version number is associated with each of a plurality of different versions of a stored item.

16. The machine readable medium of claim 15, wherein the implicit dependency relationship information associated with a plurality of software components is stored in a database with a set of explicit dependency relationship information generated by examining said plurality of software components to identify explicit dependencies.

17. A method of generating a set of information relating to software components, the method comprising the steps of:
examining at least one software component to identify an implicit dependency between at least two software components; and
storing an explicit statement of the identified implicit dependency.

18. The method of claim 17, further comprising:
associating a command with the stored explicit statement of the identified dependency.

19. The method of claim 18, further comprising:
examining a plurality of software components to identify explicit dependency relationship information.

20. The method of claim 19, further comprising:
storing a collection of identified explicit dependency relationship information in a database with said stored explicit statement of the identified implicit dependency.

21. The method of claim 20, further comprising:
monitoring to detect changes in software components; and
storing detected change information in said database.

22. The method of claim 22, wherein the stored detected change information in said database includes the value of system component information before and after a detected change.

23. The method of claim 22, wherein said software components are program components.

24. The method of claim 23, further comprising, storing in said database, the version number of a program component before and after a detected change in said program component.

25. The method of claim 22, wherein said software components are data components, the method further comprising;
storing in said database, the version number of a data component before and after a change is detected in said data component.
